(19) United States
(12) Patent Application Publication
(10) Pub. No.: US 2014/0215409 A1
(43) Pub. Date: Jul. 31, 2014

(54) ANIMATED DELETE APPARATUS AND METHOD

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,224

(22) Filed: Jan. 31, 2013

(51) Int. Cl. G06F 3/01

(52) U.S. Cl. CPC G06F 3/017
USPC 715/863

(57) ABSTRACT

A computer-implemented method is disclosed for deleting an electronic receipt. Within the method, a computer system may present a receipt image documenting a point-of-sale transaction to a customer via a display of a computing device corresponding to the customer. While the receipt image is being presented, the computer system may receive one or more multi-touch pinch commands applied by the customer to the display of the computing device. In response to such commands, the computer system may virtually crumple the receipt image in a manner tracking the one or more multi-touch pinch commands. Once the receipt image is fully crumpled and/or crumpled and flicked, the computer system may delete receipt data corresponding to the receipt image from the computer device or an account accessed through the computing device.

### BACKGROUND

1. Field of the Invention

This invention relates to point-of-sale systems and more particularly to systems and methods for improving the experience of a customer participating in an electronic receipts program.

2. Background of the Invention

Many point-of-sale (POS) systems currently in use today do not support important emerging technologies, services, and marketing opportunities. For example, many POS systems are limited in their ability to collect, analyze, and use electronic receipt data. As a result, those POS systems cannot effectively implement many novel methods and services surrounding such data. Accordingly, what is needed is an apparatus and method expanding the ability of a wide variety of POS systems and supporting computer systems, include legacy POS systems, to collect, improve, and use electronic receipt data to benefit customers.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram illustrating one embodiment of a computing device of a customer in accordance with the present invention;

FIG. 2 is a schematic block diagram of one embodiment of a point-of-sale (POS) system for implementing methods in accordance with the present invention;

FIG. 3 is a schematic block diagram of one embodiment of multiple POS systems in accordance with the present invention operating in the context of an enterprise-wide system;

FIG. 4 is a schematic block diagram of one embodiment of a receipt in accordance with the present invention;

FIG. 5 is a schematic block diagram of one embodiment of a receipt module in accordance with the present invention;

FIG. 6 is a schematic block diagram of one embodiment of an animation module in accordance with the present invention;

FIG. 7 is a block diagram of one embodiment of a method for deleting an electronic receipt in accordance with the present invention;

FIG. 8 is a schematic diagram illustrating one embodiment of a display of a customer's computing device displaying a virtual receipt after a human user has contacted the display in preparation for executing a laterally oriented multi-touch pinch or crumple command in accordance with the present invention (two contact points made by the human user are shown using hidden or dashed lines);

FIG. 9 is a schematic diagram illustrating the virtual receipt of FIG. 8 after the laterally oriented multi-touch pinch or crumple command has been applied by the human user to the display of the computing device;

FIG. 10 is a schematic diagram illustrating the virtual receipt of FIG. 9 after the human user has contacted the display in preparation for executing a longitudinally oriented multi-touch pinch or crumple command on the display of the computing device;

FIG. 11 is a schematic diagram illustrating the virtual receipt of FIG. 10 after the longitudinally oriented multi-touch pinch or crumple command has been applied by the human user to the display of the computing device;

FIG. 12 is a schematic diagram illustrating the virtual receipt of FIG. 11 after the human user has contacted the display in preparation for executing another longitudinally oriented multi-touch pinch or crumple command on the display of the computing device;

FIG. 13 is a schematic diagram illustrating the virtual receipt of FIG. 12 after the second longitudinally oriented multi-touch pinch or crumple command has been applied by the human user to the display of the computing device;

FIG. 14 is a schematic diagram illustrating the virtual receipt of FIG. 13 after the human user has contacted the display in preparation for executing a flick command on the display of the computing device; and

FIG. 15 is a schematic diagram illustrating the virtual receipt of FIG. 14 after the flick command has been applied by the human user to the display of the computing device and the virtual receipt has begun to move off of the display.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

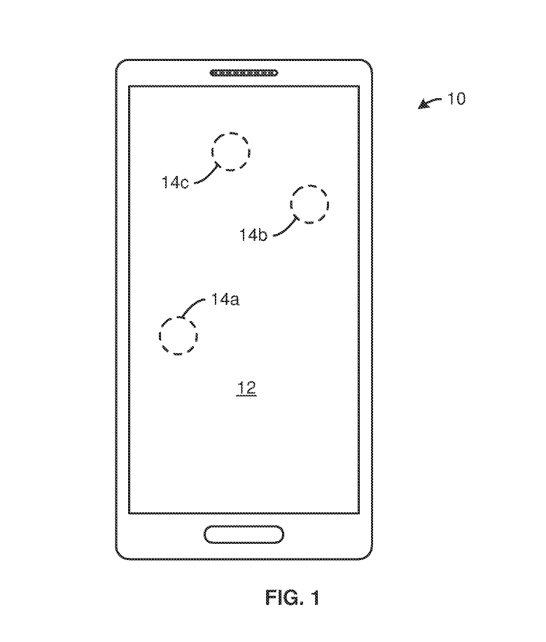

Referring to FIG. 1, selected systems or methods in accordance with the present invention may enable one or more business to build customer loyalty, rapport, good will, or the like. In certain embodiments, the systems or methods may accomplish this by providing an enhanced customer experience within a computing environment. For example, a business entity (e.g., retailer) may enable certain functions of a corresponding software application (e.g., a mobile application, receipt manager, accounting program, budgeting program, browser, or the like) to be performed or initiated in a fun or novel manner. Accordingly, a business entity may elevate a customer's interaction with a computer environment out of the mundane and into something that is more rich, creative, and memorable, thereby generating a more favorable impression on the customer. Additionally, a customer may be more likely to show a fun or novel feature to others (e.g., friends, family, co-workers, or the like), thereby expanding the number of people that may adopt or use the software application.

In selected embodiments, a business may use or leverage certain technologies to enable one or more functions to be performed or initiated in a fun or novel way. For example, in recent years, devices 10 (e.g., mobile telephones, tablet computers, and the like) with touch screens 12 have gained wide spread acceptance and use. Accordingly, in certain embodiments, a business may use touch-screen functionality and capability to support certain novel or fun features or functions within a computer environment.

In use, a touch screen 12 may function sequentially or simultaneously as both an output device and an input device. For example, a touch screen 12 may output (e.g., display) images, text, or the like or combinations thereof to a human user. Moreover, by touching a touch screen 12 in a particular manner, the human user may input or communicate one or more commands.

A device 10 with a touch screen 12 (e.g., a multi-touch touch screen) may be programmed to determine when one or more points of contact 14 are made and identify a location corresponding to each of the one or more points of contact 14. Accordingly, a device 10 with a touch screen 12 may be programmed to recognize one or more gestures. A gesture may be a particular contact 14 and/or motion applied by a human user to a touch screen 12. In general, gestures are applied to a touch screen 12 with the finger(s) and/or hand(s) of a human user. Different gestures may communicate different things (e.g., have different commands associated therewith).

For example, in certain applications or operating systems, a single tap, double tap, or the like on a touch screen 12 may be used to select a button, link, or the like corresponding to the point of contact 14. A touch and hold may be used to select an icon corresponding to the point of contact 14 for relocation on the touch screen 12. A touch followed by a slide may be used to scroll, pan, or the like in the direction of the slide. Still other commands may be issued or made in the form of multi-touch gestures.

Multi-touch gestures may be gestures that incorporate or require two or more points of contact 14. For example, in a multi-touch pinch gesture, two or more points of contact 14a, 14b, 14c may be established and then drawn toward one another across some portion of a touch screen 12. Conversely, in a multi-touch spread gesture, two or more points of contact 14a, 14b, 14c may be established and then slid away from one another across some portion of a touch screen 12.

As with simple or single-touch gestures, different multi-touch gestures may correspond to different commands. For example, a multi-touch spread gesture may undue or reverse a multi-touch pinch gesture may. Moreover, different multi-touch gestures within the same “family” or type may correspond to different commands. For example, a pinch gesture made with two points of contact 14a, 14b may be interpreted differently than a pinch gesture made with three points of contact 14a, 14b, 14c.

In selected embodiments in accordance with the present invention, one or more gestures may be used to perform or initiate some computer functionality in a fun or novel manner. For example, a delete function is a common function used in many computer environments. Accordingly, in certain embodiments, one or more gestures may be used to initiate and/or control an enhanced delete function in accordance with the present invention.

For example, in selected embodiments, one or more multi-touch pinch gestures may be used to virtually crumple a displayed page, document, image, or the like. Once the page, document, image, or the like has been reduced to a sufficiently crumpled state (e.g., is “wadded up”), it, or one or more records associated therewith, may be automatically deleted. Alternatively, once the page, document, image, or the like has been reduced to a sufficiently crumpled state, a flick command may be used to “toss” the page, document, image, or the like off a screen 12 or into a waste basket and delete the page, document, image, or the like, or one or more records associated therewith. Thus, a business entity may enable an enhanced delete function that is performed or initiated in a fun or novel manner.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

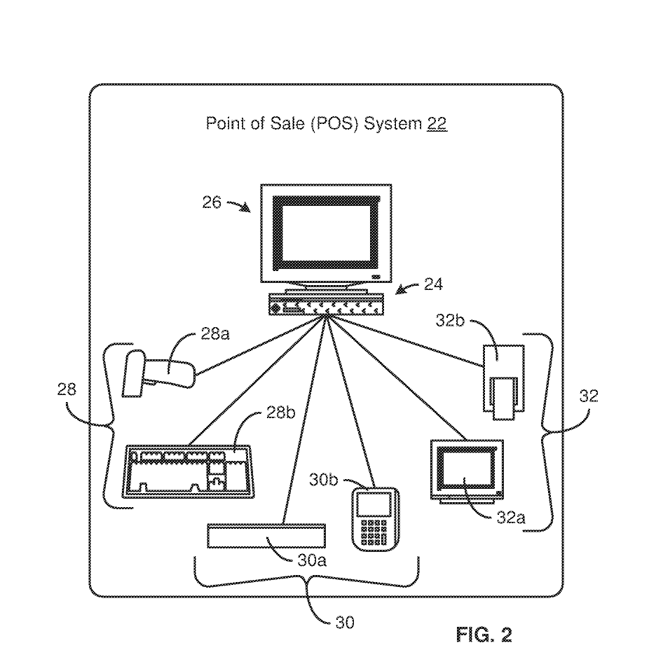

Referring to FIG. 2, an enhanced delete function in accordance with the present invention may be applied to a wide variety of pages, documents, images, or the like or one or more records corresponding thereto. For example, an enhanced delete function may be used to delete digital photographs, PDF documents, word processor documents, or the like. In selected embodiments, an enhanced delete function may be applied to an electronic receipts program, system, and/or method. Accordingly, in certain embodiments, the hardware, software, or hardware and software of a POS system 22 may be configured to implement or support one or more methods in accordance with the present invention.

A POS system 22 in accordance with the present invention may include various components. In certain embodiments, a POS system 22 may include a central or primary computer 24, a monitor 26 (e.g., a cashier-facing monitor 26), one or more input devices 28 (e.g., scanners 28a, keyboards 28b, scales, or the like), one or more payment devices 30 (e.g., cash drawers 30a, card readers 30b) for receiving or returning payments, one or more output devices 32 (e.g., customer-facing display 32a or monitor 32a, receipt printer 32b), or the like or combinations or sub-combinations thereof.

A computer 24 may form the primary processing unit of a POS system 22. Other components 28, 30, 32 forming part of a POS system 22 may communicate with the computer 24. Input devices 28 and certain payment devices 30 may feed data and commands to a computer 24 for processing or implementation. For example, a scanner 28a may pass data communicating the identity of one or more items to be purchased, returned, or the like to a computer 24. Similarly, a card reader 30b may pass payment information to a computer 24.

Conversely, output devices 32 and certain payment devices 30 may follow or implement commands issued by a computer 24. For example, a cash drawer 30a may open in accordance with the commands of a computer 24. Similarly, a customer-facing display 32a and receipt printer 32b may display or output data or information as instructed by a computer 24.

In selected embodiments, in addition to handling consumer transactions (e.g., purchases, returns), a POS system 22 may also provide or support certain “back office” functionality. For example, a POS system 22 may provide or support inventory control, purchasing, receiving and transferring products, or the like. A POS system 22 may also store sales and customer information for reporting purposes, marketing purposes, receivables management, trend analysis, cost analysis, price analysis, profit analysis, or the like. If desired or necessary, a POS system 22 in accordance with the present invention may include an accounting interface to pass certain information to one or more in-house or independent accounting applications.

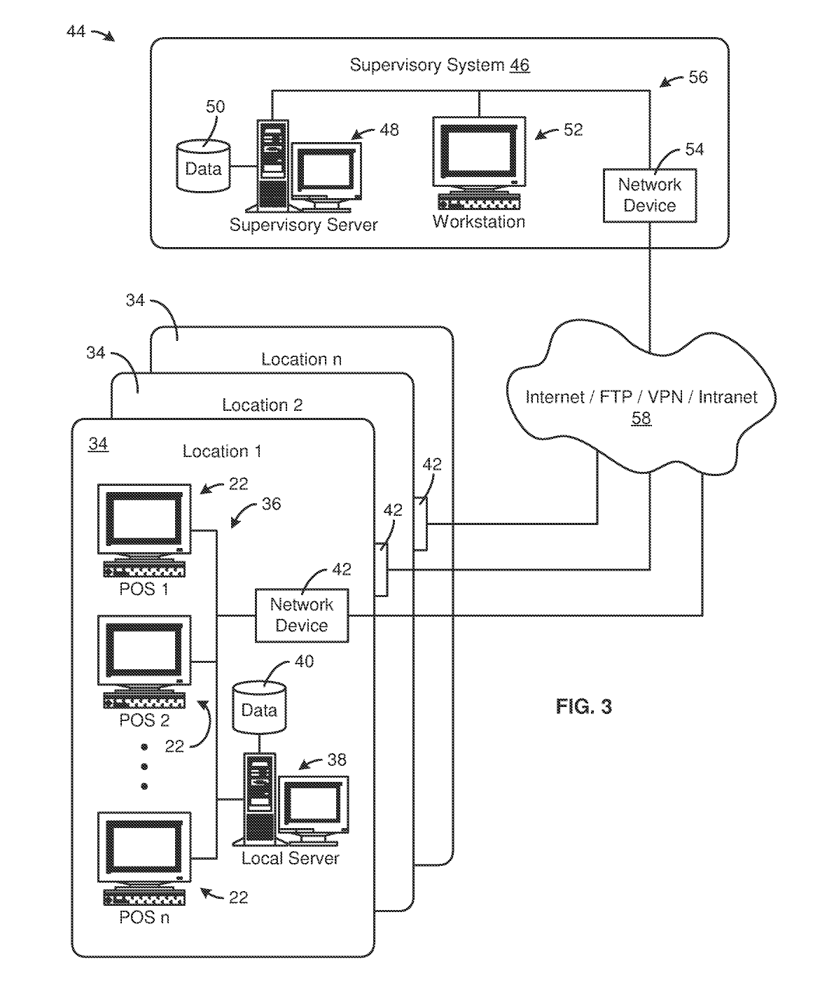

Referring to FIG. 3, in selected embodiments, a POS system 22 may operate substantially independently, as a stand-alone unit. Alternately, a POS system 22 in accordance with the present invention may be one of several POS systems 22 forming the front line of a larger system. For example, multiple POS systems 22 may operate at a particular location 34 (e.g., within a retail, brick-and-mortar store). In such embodiments, the various POS systems 22 may be interconnected via a LAN 36. A LAN 36 may also connect the POS systems 22 to a local server 38.

A local server 38 may support the operation of the associated POS systems 22. For example, a server 38 may provide a central repository from which certain data needed by the associated POS systems 22 may be stored, indexed, accessed, or the like. A server 38 may serve certain software to one or more POS systems 22. In certain embodiments, a POS system 22 may offload certain tasks, computations, verifications, or the like to a server 38.

Alternatively, or in addition thereto, a server 38 may support certain back office functionality. For example, a server 38 may receive and compile (e.g., within one or more associated databases 40) data from the various associated POS systems 22 to provide or support inventory control, purchasing, receiving and transferring products, or the like. A server 38 may also receive and compile sales and customer information for reporting purposes, marketing purposes, receivables management, trend analysis, cost analysis, price analysis, profit analysis, or the like.

In certain embodiments, one or more POS systems 22 or servers 38 corresponding to a particular location 34 may communicate with or access one or more remote computers or resources via one or more network devices 42. For example, a network device 42 may enable a POS system 22 to contact outside resources and verify the payment credentials (e.g., credit card information) provided by a customer. A network device 42 may comprise a modem, router, or the like.

In selected embodiments, a POS system 22 in accordance with the present invention may operate within an enterprise-wide system 44 comprising multiple locations 34 (e.g., branches 34 or stores 34). In such embodiments, each location 34 may have one or more POS systems 22, local servers 38, local databases 40, network devices 42, or the like or combinations or sub-combinations thereof connected by a computer network (e.g., a LAN 36). Additionally, each such location 34 may be configured to interact with one or more supervisory systems 46. For example, multiple branch locations 34 may report to an associated “headquarters” location or system.

A supervisory system 46 may comprise one or more supervisory servers 48, databases 50, workstations 52, network devices 54, or the like or combinations or sub-combinations thereof. The various components of a supervisory system 46 may be interconnected via a computer network (e.g., a LAN 56). In selected embodiments, a supervisory system 46 may comprise one or more supervisory servers 48 providing a central repository from which certain data needed by the one or more POS systems 22 or local servers 38 may be stored, indexed, accessed, or the like.

Alternatively, or in addition thereto, a supervisory server 48 may receive and compile (e.g., within one or more associated databases 50) data from the various associated POS systems 22 or local servers 38 to provide or support inventory control, purchasing, receiving and transferring products, or the like. A supervisory server 48 may also receive and compile sales and customer information for reporting purposes, marketing purposes, receivables management, trend analysis, cost analysis, price analysis, profit analysis, or the like.

A supervisory system 46 may be connected to one or more associated locations 34 or branches 34 in via any suitable computer network 58 (e.g., WAN 58). For example, in selected embodiments, one or more locations 34 may connect to a supervisor system 46 via the Internet. Communication over such a network 58 may follow any suitable protocol or security scheme. For example, communication may utilize the File Transfer Protocol (FTP), a virtual private network (VPN), intranet, or the like.

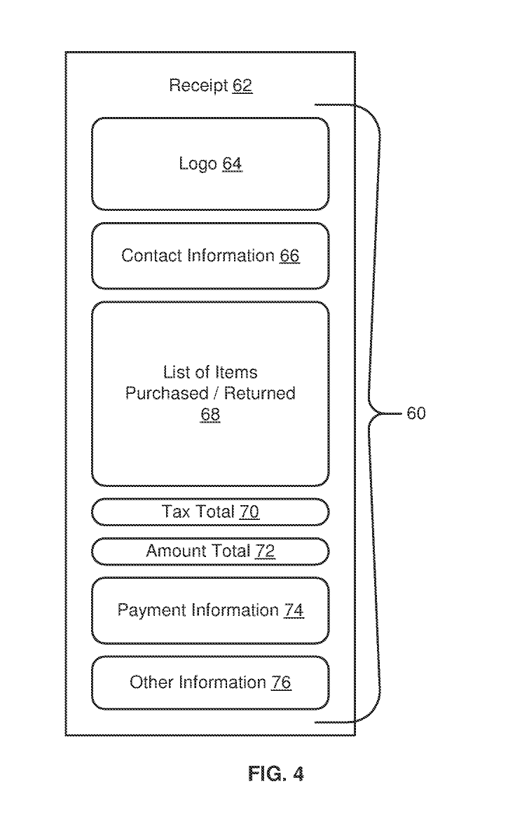

Referring to FIG. 4, a POS system 22 may collect and/or generate receipt data 60. Receipt data 60 may document a transaction (e.g., sale or return) carried out by a POS system 22. Receipt data 60 may be presented or displayed to a customer in the form of receipt 62 (e.g., a hardcopy receipt, “paperless” electronic receipt, or the like or a combination thereof). In selected embodiments, receipt data 60 may be delivered electronically to a customer's computing device (e.g., a device 10 with a touch screen 12, mobile telephone, personal digital assistant (PDA), media player, tablet computer or reader, laptop computer, desktop computer, or the like or a combination or sub-combination thereof, hereinafter a “computing device”) by an entity's computer system (e.g., a system comprising one or more POS systems 22, local servers 38, supervisory servers 48, some other onsite resources, one or more applications running on a customer's computing device, some other offsite resources, or the like or combinations or sub-combinations thereof, hereinafter a “computer system”).

In selected embodiments, receipt data 60 and a receipt 62 may include a logo 64, contact information 66, a list 68 of items purchased or returned, a total 70 indicating the sales tax assessed or returned, a total 72 indicating the amount paid or returned, payment information 74, other information 76, or the like or combinations or sub-combinations thereof.

A logo 64 may reinforce the brand and image of the associated entity within the mind of a consumer. By including contact information 66 on a receipt 62, an entity may ensure that a customer has ready access to one or more physical addresses, Internet address, telephone numbers, facsimile numbers, hours of operation, or the like or combinations or sub-combinations thereof. One or more of a list 68 of items purchased or returned, a total 70 indicating the sales tax assessed or returned, a total 72 indicating the amount paid or returned, and payment information 74 (e.g., date of transaction, an indication of method of payment, an indication of which credit or debit card was used, etc.) may be included to document important details of a transaction.

Other information 76 may be included within a receipt 62 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

A receipt 62 passed to a computing device of a customer in electronic format may be presented by the computing device in any suitable layout or format. For example, the receipt data 60 forming a receipt 62 may simply be presented as a textual list. Alternatively, an electronic version of the receipt 62 may follow the form of a paper receipt. That is, a receipt 62 in an electronic format may be a virtual receipt comprising a virtual representation or layout substantially matching what a comparable paper receipt would look like.

The manner in which a receipt 62 in an electronic format is presented or displayed on a computing device of a customer may be completely dictated by the computer system delivering the receipt data 60 thereto. Alternatively, the computing device of the customer may have an application (e.g., a receipt manager, accounting program, budgeting program, browser, or the like) installed thereon. Such an application may partially or completely control the layout or format of receipt data 60 displayed therewith or therethrough. For example, a computer system may supply receipt data 60, while the application installed on the computing device of the customer supplies the layout or formatting.

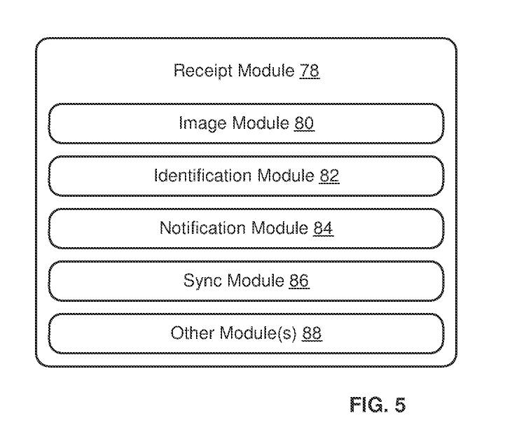

Referring to FIG. 5, a computer system in accordance with the present invention may deliver receipt data 60 to a printer 32b, computing device of a customer, or the like in any suitable manner. In selected embodiments, a receipt module 78 may enable or support such delivery. A receipt module 78 may include any suitable arrangement of sub-components or modules. In certain embodiments, a receipt module 78 may include an image module 80, identification module 82, notification module 84, synchronization module 86, one or more other modules 88 as desired or necessary, or the like or some combination or sub-combination thereof.

An image module 80 may assemble, generate, or obtain an advertisement comprising a call to action. A call to action may invite or motivate a customer to take a particular step or action. For example, a call to action may invite or motive a consumer to download receipt data 60. Alternatively, a call to action may invite or motive a customer to obtain an electronic receipt application, participate in an electronic receipt program, or the like.

To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 60 encoded within the code. Alternatively, scanning the code may initiate the download of receipt data 60, the download of an application for receiving and/or displaying receipt data 60, enrollment in an electronic receipt program, or the like or a combination or sub-combination thereof.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data 60 may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 82 may be tasked with requesting, collecting, and/or communicating identification information linking a customer associated with a transaction with one or more records stored within a computer system. For example, as part of a transaction carried out at a POS system 22, an identification module 82 may request, collect, and/or communicate identification information linking a transaction to a particular computing device or account corresponding to the customer participating in the transaction. Thus, information corresponding to the transaction may be passed to the customer via the particular computing device or account.

An identification module 82 may request, collect, and/or communicate one or more types of identification information. For example, in selected embodiments, an identification module 82 may collect a unique identification or membership number from a customer. This may be done when a membership card, club card, loyalty card, identification card, credit card, debit card, fingerprint or other biometric characteristic, or the like is scanned, input, or otherwise collected at a POS system 22. In other situations, a cashier or customer may type in a unique identification number, payment number, membership number, or the like at a POS system 22. For example, while a cashier is processing a transaction, a customer may be prompted via a card reader 30b, customer-facing display 32a, or the like to enter (e.g., type in using the card reader 30b) a mobile telephone number corresponding to the customer. Alternatively, a cashier may type in a telephone number corresponding to the customer.

Once the identification information is received, it may be used directly (e.g., used directly to pass receipt data 60 to a computing device of a corresponding customer). Alternatively, or in addition thereto, the identification information may tie or link a current transaction to one or more previously stored computer records. For example, within such records, a computer system may find the information necessary to identify and communicate with a computing device or account of a corresponding customer. Alternatively, or in addition thereto, such records may enable a computer system to tie or link a current transaction to an appropriate computing device or account.

A notification module 84 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 62 is available for download).

A synchronization module 86 may support or enable one way or two way data communication between a computer system and a computing device. For example, a synchronization module 86 may support or enable the passing of receipt data 60 or updated receipt data 60 from a computer system to a computing device. A synchronization module 86 may also enable certain data received from a computing device to be incorporated within or used by a computer system. For example, one or more user preferences (e.g., notification preferences) may be communicated to a computer system from an application resident on a computing device.

The various functions or modules of a receipt module 78 may be enacted or implemented by any suitable system or component thereof. For example, in selected embodiments, one or more functions or modules of a receipt module 78 may be distributed across one or more hardware devices, including a primary computer 24 of a POS system 22, a local server 38, a supervisory server 48, some other onsite resource, a computing device, some other offsite resource, or the like or combinations or sub-combinations thereof. Thus, systems and methods in accordance with the present invention may be adapted to a wide variety of situations, including more rigid legacy systems.

Referring to FIG. 6, in selected embodiments, one or more computers, computers systems, computing devices (e.g., mobile computing devices), or the like or a combination or sub-combination thereof may support or enable an animation module 90. An animation module 90 may provide, support, or enable an enhanced delete function in accordance with the present invention. An animation module 90 may include any suitable arrangement of sub-components or modules. In certain embodiments, an animation module 90 may include an input module 92, transform module 94, output module 96, one or more other modules 98 as desired or necessary, or the like or a combination or sub-combination thereof.

An input module 92 may receive one or more inputs required for the proper execution of an enhanced delete function. For example, an input module 92 may receive one or more inputs or instructions generated by an operating system in response to one or more gestures applied to a touch screen 12 of a computing device of a customer. In selected embodiments, an input module 92 may process one or more inputs or instructions received thereby. For example, an input module 92 may convert one or more inputs or instructions into information having a form that is recognizable and/or usable by a transform module 94.

A transform module 94 may receive information from an input module 92 and modify one or more pages, documents, images, or the like in accordance with the information. For example, a customer may wish to delete a receipt 62 on his or her computing device. Accordingly, the customer may apply a longitudinally oriented multi-touch pinch gesture to a displayed image of the receipt 62 to communicate his or her desire to virtually crumple the receipt 62 in the longitudinal direction. The details of the longitudinally oriented multi-touch pinch gesture may be reflected in the information provided to a transform module 94 by a corresponding input module 92. Accordingly, the transform module 94 may modify the receipt 62 in accordance with the information and longitudinally crumple the receipt 62 shown in the displayed image.

In selected embodiments, a significant portion of the enjoyment derived by one or more customers from an enhanced delete function may be the realism associated therewith. Accordingly, a transform module 94 may be programmed to closely track a multi-touch gesture in location, direction, timing, or the like or a combination or sub-combination thereof.

That is, a significant amount of information corresponding to a multi-touch gesture may be passed from an input module 92 to a transform module 94. Such information may correspond to the initial locations of the two or more points of contact 14 with respect to the displayed image of the receipt 62, the directions of travel of the two or more points of contact 14 with respect to the displayed image of the receipt 62, the speed of travel of the two or more points of contact 14 across the screen 12, or the like or combinations or sub-combinations thereof.

Thus, if, in a multi-touch pinch gesture, two points of contact 14 are made and drawn together, then the two corresponding locations on the receipt 62 may be virtually drawn together in the same manner. This may include the directions of travel, speed of travel, or the like. Conversely, if, in a multi-touch pinch gesture, two points of contact 14 are made and drawn apart, then the two corresponding locations on a virtually crumpled receipt 62 may be virtually drawn apart (uncrumpled) in the same manner. Thus, a receipt 62 may crumple or uncrumple in real time as if the gestures were producing an actual physical crumpling or uncrumpling of the receipt 62. Moreover, the resulting virtual crumpling or uncrumpling of the displayed receipt 62 may model the crumpling or uncrumpling one might expect to see if an actual pinching of the same motions were applied to an actual receipt of similar dimensions.

In selected embodiments, a transform module 94 may ignore the “momentum” of a gesture. Accordingly, a virtual crumpling or uncrumpling may only extend as far as the actual travel of a corresponding gesture. Alternatively, a transform module 94 may factor in the momentum associated with a gesture. In selected momentum calculations, one or more assigned “weights” may be nominal or relatively small to provide a realistic animation. Accordingly, a virtual crumpling or uncrumpling may extend some distance beyond the actual travel of a corresponding gesture in proportion to the speed thereof. A gesture executed at a higher speed may produce more virtual crumpling or uncrumpling than the same gesture executed at a lower speed. Additionally, a gesture executed at relatively low speed may result in substantially no additional virtual crumpling or uncrumpling.

A transform module 94 may implement or apply any suitable graphical transformation or mathematical manipulation to provide the desired modifications to the displayed images. In selected embodiments, one or more graphical transformations or mathematical manipulations may be recorded or codified in the form of one or more rules 100 implemented or applied by a transform module 94. In certain embodiments, a transform module 94 may utilize or apply one or more affine transformations.

An output module 96 may support or enable the passing and/or presenting of modified pages, documents, or images to one or more customers. For example, an output module 96 may support or enable the presenting of one or more virtually crumpling or crumpled receipts 62 to one or more customers. This may be accomplished in any suitable manner. For example, in selected embodiments, an output module 96 may work with a transform module 94 to display on a touch screen 12 of a customer's computing device a series of images providing progressive crumpling (or uncrumpling) that closely tracks a corresponding gesture.

A computer system in accordance with the present invention may include a deletion module. In selected embodiments, a deletion module may comprise one of the other modules 98 and form part of an animation module 90. Alternatively, a deletion module may be more closely associated with other components of a computer system. For example, a deletion module may be included within or associated with an application running on a computing device of a customer.

A deletion module may be programmed to delete one or more pages, documents, images, or the like or one or more records corresponding thereto when one or more conditions are satisfied. In selected embodiments, such conditions may include a selected or threshold degree of crumpling of an on-screen image, a flick command applied by a human user to a crumpled on-screen image via a touch screen, or the like or a combination thereof.

The various functions or modules of an animation module 90 may be enacted or implemented by any suitable system or component thereof. For example, in selected embodiments, one or more functions or modules of an animation module 90 may be distributed across one or more hardware devices, including a primary computer 24 of a POS system 22, a local server 38, a supervisory server 48, some other onsite resource, a computing device, some other offsite resource, or the like or combinations or sub-combinations thereof. Thus, systems and methods in accordance with the present invention may be adapted to a wide variety of situations, including more rigid legacy systems.

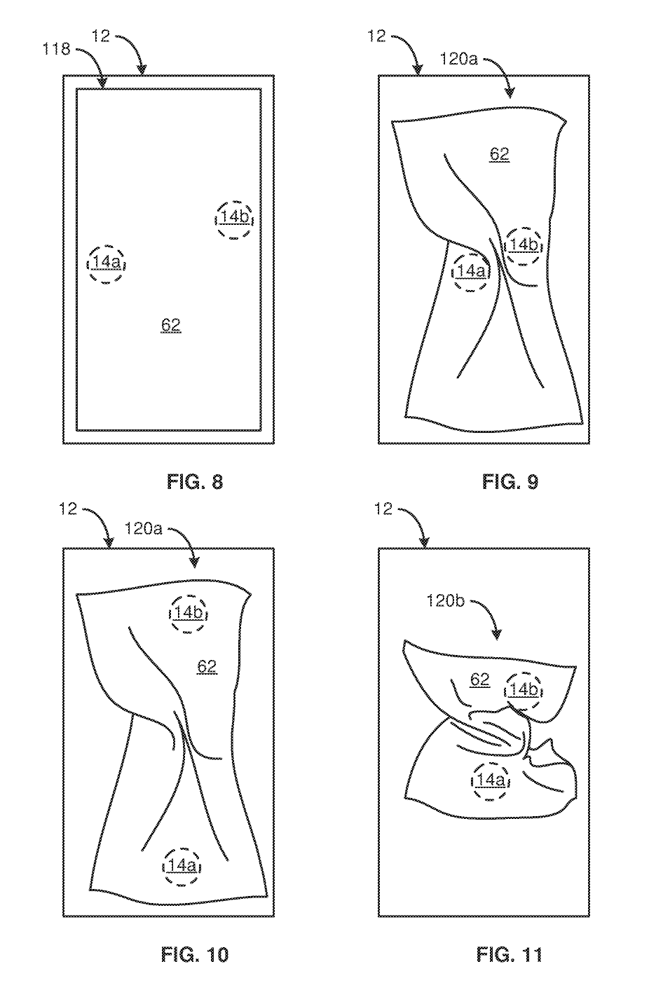

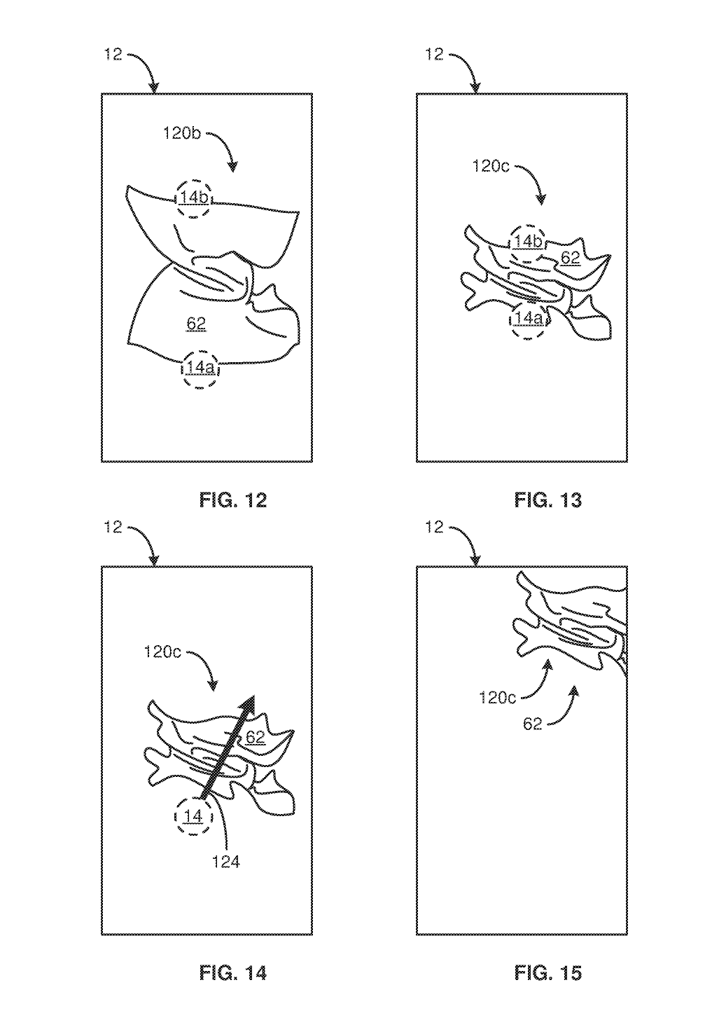

Referring to FIGS. 8-15, one method 102 in accordance with the present invention may begin when an appropriate application (e.g., a retailer's mobile application, an electronic receipts application, browser, or the like or a combination or sub-combination thereof) is issued 104 and installed on a computing device of a customer. In selected embodiments, a computer system may then enroll the customer in an electronic receipts program. In certain embodiments, this enrollment may result in the computing device (or an application installed thereon) being linked to or associated with certain identification information within the records of a computer system.

In other embodiments, the enrollment may be independent of any specific computing device. For example, in selected embodiments, enrollment may comprise the generation of an account. The customer may then access the account (e.g., “log into” the account) using a computing device. Accordingly, a customer may access the account via an appropriate application (e.g., browser) running on any one of several computing devices. Moreover, by “logging out” of an account, the corresponding computing device may be separated from the account.

So prepared, a customer may then enter a “brick-and-mortar” business location (e.g., enter a brick-and-mortar retail store with his or her computing device), select one or more items for purchase, and approach a POS system 22. At the POS system 22, a POS transaction (e.g., a purchase of one or more products) may be initiated 106.

During the transaction, a computer system may receive identification information. For example, a POS system 22 may scan a membership card, club card, loyalty card, identification card, credit card, debit card, finger print, or the like. From the scan, identification information (e.g., a unique identification number, membership number, or the like) may be obtained. Alternatively, while a cashier is processing a transaction, a customer may be prompted via a card reader 30b, customer-facing display 32a, or the like to enter (e.g., type in using the card reader 30b) an identification number (e.g., a mobile telephone number).

Identification information may be passed from a POS system 22 to one or more other computers (e.g., servers 38, 48) within a computer system. The identification information may link a customer and a corresponding transaction to one or more records stored within a computer system. In selected embodiments, such records may contain the information necessary to identify and communicate with a computing device or account of the corresponding customer. Accordingly, a computer system may deliver receipt data 60 documenting the transaction to an appropriate computing device or account.

During the transaction or sometime thereafter, a computer system may generate 108 or collect 108 receipt data 60 documenting the transaction and deliver 110 the same to the customer (e.g., to the application or account of the customer). Accordingly, a receipt 62 (e.g., a virtual receipt substantially matching what a comparable paper receipt would look like) may be presented 112 to the customer on his or her computing device.

At some point in time, while viewing the receipt 62 on a computing device, the customer may desire to delete the receipt 62. To that end, the customer may apply or input a crumple command. For example, the customer may contact a touch screen 12 of the computing device and execute a laterally oriented multi-touch pinch gesture. Accordingly, a computer system in accordance with the present invention may receive 114, while presenting the receipt 62, a crumple command from the customer.

In selected embodiments, a computer system may require a gesture to include certain characteristics for it to be received 114 or interpreted as a crumple command. For example, in selected embodiments, a computer system may require such a gesture to comprise a multi-touch pinch comprising at least two points of contact 14. In other embodiments, a computer system may require such a gesture to comprise a multi-touch pinch comprising at least three points of contact 14. In still other embodiments, a computer system may require such a gesture to comprise a multi-touch pinch comprising at least four points of contact 14.

Alternatively, or in addition thereto, a computer system may require a gesture to occur within a particular context or view for it to be received 114 or interpreted as a crumple command. For example, in selected embodiments and situations, a computer system may interpret a multi-touch pinch comprising at least two points of contact 14 as a “zoom out” command. Accordingly, if zoomed in, the computer system may interpret a multi-touch pinch comprising at least two points of contact 14 as a “zoom out” command. Thus, only after an active view is fully zoomed out (e.g., zoomed out to display the entire width of the receipt 62, zoomed out to display the entire length of the receipt 62, or the like) will a gesture comprising a multi-touch pinch comprising at least two points of contact 14 be interpreted as a crumple command.

In selected embodiments, rather than relying on a particular context or view, a computer system may use the number of contact points 14 to distinguish between a zoom out command or the like and a crumple command. For example, a computer system may interpret a multi-touch pinch consisting of two points of contact 14 as a zoom out and a multi-touch pinch comprising at least three points of contact 14 as a crumple command. In still other embodiments, certain views, situations, or the like may not support any zoom functionality. Accordingly, in such views, situations, or the like, any multi-touch pinch comprising at least two points of contact 14 may be interpreted as a crumple command.

After receiving 114 a crumple command, a computer system may virtually crumple 116 the receipt 62. For example, a computer system may respond to a laterally oriented multi-touch pinch gesture by virtually crumpling 116 the receipt 62 in the lateral direction according to the positions, directions, and speed associated with the gesture. In selected embodiments, such crumpling 116 may be incremental in nature. That is, a computer system need not wait until an entire gesture is complete before crumpling 116. Rather, the gesture may be interpreted, and the crumpling 116 displayed, in increments such that, to the customer, the crumpling 116 occurs substantially in real time with, and closely track, the gesture.

In selected embodiments, a computer system may impose a threshold requirement. A threshold may prevent a customer from inadvertently deleting a receipt 62. Thus, rather than asking the customer if he is sure he wants to delete the receipt 62, the computer system may simply require a certain amount of crumpling of the receipt 62 (e.g., a selected decrease in the area covered by the receipt 62) before a delete is executed or becomes available as an option.

If a threshold is being applied and the virtual crumpling 116 produced thus far is insufficient to satisfy the threshold, then the computer system may wait to receive further instructions from the customer. If the computer system receives 114 another crumple command, the receipt 62 may be further crumpled 116 in accordance with that command. This may continue until the threshold is satisfied.

For example, as shown in the progression within FIGS. 8-15, a first multi-touch pinch may transition a receipt 62 from an uncrumpled condition 118 to a first crumpled condition 120a. A second multi-touch pinch may transition the receipt 62 from the first crumpled condition 120a to a second crumpled condition 120b that is more crumbled than the first crumpled condition 120a. A third multi-touch pinch may transition the receipt 62 from the second crumpled condition 120b to a third crumpled condition 120c that is more crumbled than the second crumpled condition 120b. For purposes of discussion, the third crumpled condition 120c may be deemed to satisfy the threshold. However, a threshold may be set to be more or less restrictive than the level of compaction illustrated for the third crumpled condition 120c.

In selected embodiments, once a threshold is met, the receipt 62, or one or more records corresponding thereto, may be automatically deleted 122. Alternatively, after a threshold is met, some additional action or command from the customer may be required to delete the receipt 62. For example, in certain embodiments, a flick gesture 124 or the like must be received 126 in order to launch the now crumpled receipt 62 off the visible area of the touch screen 12, into a trajectory toward a displayed waste basket, or the like and initiate the deletion of the receipt 62 or one or more records corresponding thereto. Either way, however, a receipt 62 may be deleted without a customer ever browsing or selecting from any text-based menu or the like.

A method 102 in accordance with the present invention may support uncrumpling of a receipt 62. For example, a customer may have inadvertently caused the crumpling 116. Alternatively, sometime after a receipt 62 has been at least partially crumpled 116, a customer may decide not to delete a receipt 62. In either situation, the customer may apply or input an uncrumple command. For example, the customer may contact a touch screen of the computing device and execute a multi-touch spread gesture. Accordingly, a computer system in accordance with the present invention may receive 128, while presenting the receipt 62, an uncrumple command from the customer.

A computer system may require a gesture to include certain characteristics for it to be received 128 or interpreted as an uncrumple command. In selected embodiments, the requirements for an uncrumple gesture may match or track those set forth hereinabove for a crumple gesture, with the only change being that the uncrumple gesture involves a multi-touch spread as opposed to a multi-touch pinch.

After receiving 128 an uncrumple command, a computer system may virtually uncrumple 130 the receipt 62. For example, a computer system may respond to a laterally oriented multi-touch spread gesture by virtually uncrumpling 130 the receipt 62 in the lateral direction according to the positions, directions, and speed associated with the gesture. As with the crumpling 116, such uncrumpling 130 may be incremental in nature. That is, a computer system need not wait until an entire gesture is complete before uncrumpling 130. Rather, the gesture may be interpreted, and the uncrumpling 130 displayed, in increments such that, to the customer, the uncrumpling 130 occurs substantially in real time with, and closely track, the gesture.

In selected embodiments, a computer system may impose a threshold requirement in an uncrumpling process. A threshold may prevent a customer from inadvertently switching between a crumpling process and an uncrumpling process. Thus, rather than asking the customer if he is sure he wants to restore the receipt 62, the computer system may simply require a certain amount of uncrumpling of the receipt 62 (e.g., a selected increase in the area covered by the receipt 62) before restoring the receipt to an uncrumpled condition 118.

If a threshold is being applied and the virtual uncrumpling 130 produced thus far is insufficient to satisfy the threshold, then the computer system may wait to receive further instructions from the customer. If the computer system receives 128 another uncrumple command, the receipt 62 may be further uncrumpled 130 in accordance with that command. This may continue until the threshold is satisfied.

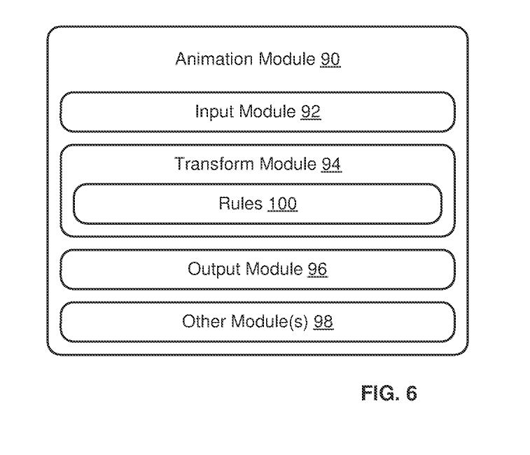

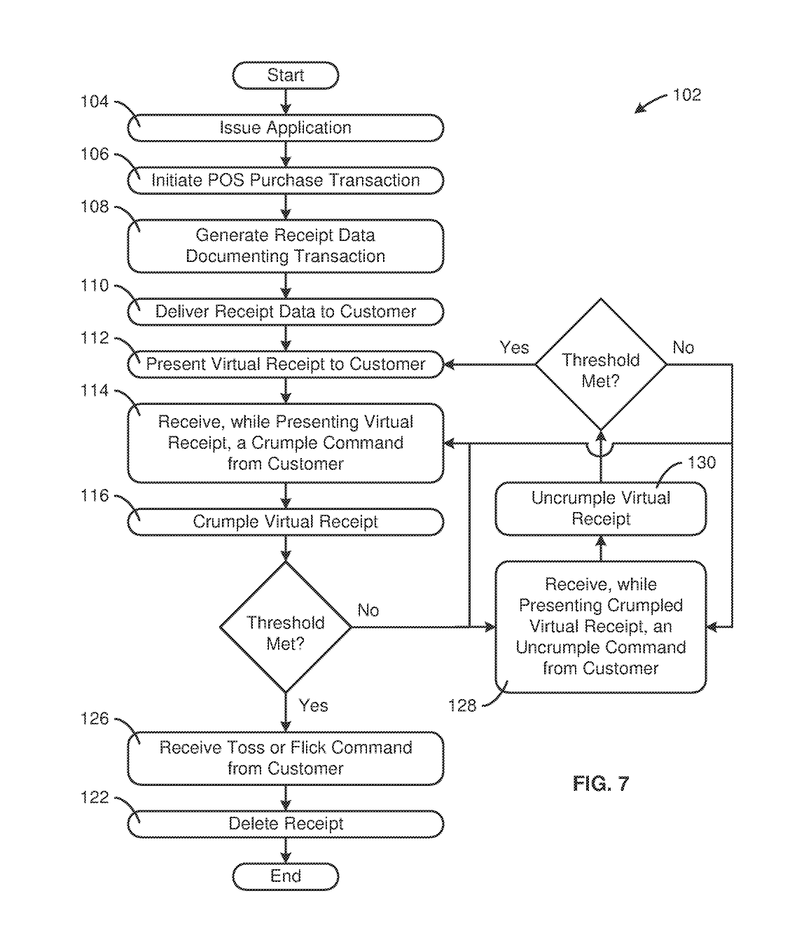

The flowchart in FIG. 7 illustrates the architecture, functionality, and operation of possible implementations of systems, methods, and computer program products according to certain embodiments of the present invention. In this regard, each block in the flowchart may represent a module, segment, or portion of code, which comprises one or more executable instructions for implementing the specified logical function(s). It will also be noted that each block of the flowchart illustration, and combinations of blocks in the flowchart illustration, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

In the foregoing, an enhanced delete function in accordance with the present invention has been explained in the context of an electronic receipts program. However, as stated earlier, an enhanced delete function may be applied to a wide variety of pages, documents, images, or the like. Accordingly, the specific application of an enhanced delete function to an electronic receipts program should be viewed as illustrative and not limiting.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A computer-implemented method for deleting one or more records, the method comprising:
presenting, by a computer system, an image to a human user via a display of a computing device corresponding to the human user;
receiving, by the computer system during the presenting, one or more multi-touch pinch commands applied by the human user to the display of the computing device;
crumpling virtually, by the computer system during the presenting, the image in a manner tracking the one or more multi-touch pinch commands; and
deleting, by the computer system, one or more records corresponding to the image after the crumpling.

2. The method of claim 1, wherein the computer system comprises an application installed on the computing device.

3. The method of claim 1, further comprising receiving, by the computer system after the crumpling and before the deleting, a flick command applied by the human user to the image on the display of the computing device.

4. The method of claim 3, further comprising moving, by the computer system after the receiving of the flick command, the image off the display in a direction matching that of the flick command.

5. The method of claim 4, wherein the deleting occurs automatically in response to the flick command.

6. The method of claim 1, wherein the deleting comprises deleting the image or one or more records corresponding thereto from the computing device.

7. The method of claim 1, wherein at least one of the one or more multi-touch pinch commands comprises a two-finger pinch gesture applied by the human user to the display of the computing device.

8. The method of claim 1, wherein at least one of the one or more multi-touch pinch commands comprises a three-finger pinch gesture applied by the human user to the display of the computing device.

9. The method of claim 1, wherein at least one of the one or more multi-touch pinch commands comprises a three or more finger pinch gesture applied by the human user to the display of the computing device.

10. The method of claim 1, wherein the deleting occurs automatically when a selected degree of crumpling of the image is achieved.

11. A computer-implemented method for deleting an electronic receipt, the method comprising:
presenting, by a computer system to a customer via a display of a computing device corresponding the customer, a receipt image documenting a point-of-sale transaction;
receiving, by the computer system during the presenting, one or more multi-touch pinch commands applied by the customer to the display of the computing device;
crumpling virtually, by the computer system during the presenting, the receipt image in a manner tracking the one or more multi-touch pinch commands; and
deleting, by the computer system, receipt data corresponding to the receipt image after the crumpling.

12. The method of claim 11, wherein the deleting comprises one of deleting the receipt data from the computing device and deleting the receipt data from an account corresponding to the customer maintained by the computer system.

13. The method of claim 11, further comprising initiating, by a point-of-sale system forming part of the computer system, the point-of-sale transaction involving the customer.

14. The method of claim 13, wherein the point-of-sale system is contained within a brick-and-mortar store corresponding to a retailer.

15. The method of claim 14, wherein the initiating comprises receiving the first customer within the brick-and-mortar store.

16. The method of claim 15, wherein the computer system comprises an application installed on the computing device.

17. The method of claim 11, further comprising receiving, by the computer system after the crumpling and before the deleting, a flick command applied by the customer to the receipt image on the display of the computing device.

18. The method of claim 17, further comprising moving, by the computer system after the receiving of the flick command, the receipt image off the display in a direction matching that of the flick command.

19. The method of claim 11, wherein the computing device comprises a mobile telephone possessed by the customer.

20. A computer system comprising:
one or more processors;
one or more memory devices operably connected to the one or more processors;
the one or more memory devices collectively storing
an input module programmed to receive one or more multi-touch pinch commands applied by a human user to a touch screen of a computing device,
a transform module programmed to virtually crumple an image in a manner tracking the one or more multi-touch pinch commands;
a deletion module programmed to delete one or more records corresponding to the image when a condition is satisfied, the condition being at least one of a selected degree of crumpling of the image and a flick command applied by the human user to a crumpled version of the image on the touch screen of the computing device.
